(19) United States
(12) Patent Application Publication
(10) Pub. No.: US 2015/0013723 A1
(43) Pub. Date: Jan. 15, 2015

(54) Chemical Meting System

(71) Applicant: NCH Corporation, Irving, TX (US)

(72) Inventors: Christina Bond Burton, Bedford, TX (US); Jose Eduardo G. Evaro, Mansfield, TX (US); Robert C. Pearce, III, Arlington, TX (US); Scott Martell Boyette, Irving, TX (US)

(21) Appl. No.: 14/325,853

(22) Filed: Jul. 8, 2014

Related U.S. Application Data
(60) Provisional application No. 61/843,605, filed on Jul. 8, 2013.

(51) Int. Cl. B08B 3/08; F17D 1/00

(52) U.S. Cl. CPC B08B 3/08; F17D 1/00
USPC 134/18; 137/561 R; 137/1

(57) ABSTRACT

A chemical meting system to dispense a known or pre-determined amount of cleaning or treating fluid without requiring any moving mechanical parts or power source, for use in fluid tanks having a volume of liquid periodically varying between a high and low level. The system utilizes the pressure changes created by the varying volume of liquid in the tank to push air from a first chamber into a second chamber containing the cleaning or treating fluid to be dispensed. The volume of air displaces a volume of the fluid to be dispensed. Once the pressure in the first chamber is equalized, the dispensing stops until the next cycle when the volume of liquid in the tank changes.

### RELATED APPLICATION

This application claims the benefit of U.S. Provisional Application Ser. No. 61/843,605 filed on Jul. 8, 2013.

### BACKGROUND OF THE INVENTION

1. Field of the Invention

This invention relates to a system to mete an amount of a fluid, such as a treating or cleaning fluid, and dispense the fluid to a desired location. The meting system utilizes hydraulic and air pressure equalization in another fluid system having a liquid substance that has a cyclical or intermittent rise and fall in volume or level, such as a toilet tank, to mete the amount of fluid.

2. Description of Related Art

There are numerous known devices for dispensing an amount of fluid to a desired location. Many of these devices rely on mechanical or electrical components to dispense the fluid, including electrical pumping systems, mechanical pumping systems, and rotating feeder systems. Failure of these devices can result from malfunction of the moving parts or disruption of power. Many different applications benefit from periodic dispensing of treating or cleaning fluids, such as toilets and septic systems, swimming pools and spas, industrial cooling towers, and insect control systems. For example, relatively complex spraying devices are commercially available for automatically spraying a cleaning fluid into a toilet bowl. These devices have the disadvantage of requiring a power source and having moving parts that are more susceptible to malfunction. Other devices that do not require power, but still involve moving parts, are also known. For example, U.S. Pat. No. 4,896,382 discloses a device that sits on the bottom of a toilet tank and has a float device to regulate air flow when the toilet is flushed to dispense cleaning solution.

Other devices, such as that disclosed in U.S. Pat. No. 3,769,640, do not have moving parts or require power, but are designed for use with solid cleaning chemicals that slowly dissolve upon contact with the water in the toilet tank. The use of solid chemicals dissolved in water may result in varying concentrations of the resulting solution being dispensed. Additionally, many of these types of devices dispense the cleaning fluid directly into the toilet tank, where cleaning is not particularly needed and where the corrosive nature of some cleaning products may damage the internal components of the tank, when it is most desirable to dispense to the toilet bowl where cleaning is desired. It is desirable to have a simple apparatus without moving parts or requiring a power source for operation, to dispense an amount of such cleaning or treating fluids with greater ability to control the concentration of the cleaning or treating fluid in the fluid or water source to which it is dispensed and ability to dispense the cleaning or treating fluid directly to an area to be treated, such as a toilet bowl.

### SUMMARY OF THE INVENTION

A non-mechanical, non-electrical system according to the invention allows a known or pre-determined amount of cleaning or treating fluid to be dispensed to achieve a given concentration in the fluid or water source being treated. The system is useful in fluid tanks, reservoirs, and fluctuating hydraulic fluid systems, such as a toilet tank, having cyclical or intermittent changes in liquid volume and corresponding changes in gas (usually air) volume. One preferred embodiment of the invention comprises a set of chambers connected together by tubing, one chamber holding a cleaning or treating fluid and the other having a liquid or water level that changes with the changing volume of liquid or water in the fluid tank. Through hydraulic and air pressure equalization, an amount of cleaning or treating fluid is dispensed each time the volume in the fluid tank changes.

According to another preferred embodiment, a second tube connects the chamber holding the cleaning or treating fluid to a desired dispensing location, which is most preferably located remotely from the fluid tank in which the apparatus is used. For example, the second tube may dispense the cleaning or treating fluid directly into a toilet bowl after a flush and as the bowl is filling, which allows for greater residence time of the cleaning or treating fluid within the bowl between flushes and prevents contact between the cleaning or treating fluid and the internal components of the toilet tank, which may cause corrosion or otherwise be damaging to those internal components.

### BRIEF DESCRIPTION OF THE DRAWINGS

The system of the invention is further described and explained in relation to the following drawings wherein:

FIG. 1 is a perspective view of one embodiment of a chemical meting system according to the invention; and

FIG. 2 is cross-sectional view of the system of FIG. 1.

### DESCRIPTION OF THE PREFERRED EMBODIMENTS

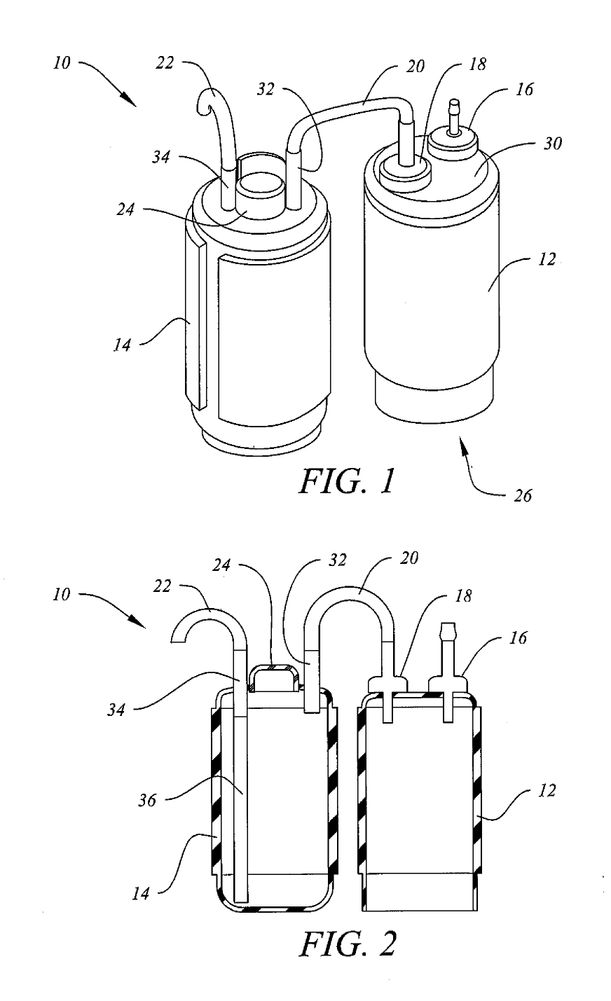

Referring to FIGS. 1-2, one preferred embodiment of a meting apparatus 10 for use in a tank holding a variable volume of liquid and gas (air) is depicted. Meting apparatus 10 preferably comprises a first chamber 12 connected to a second chamber 14 by tubing 20. The first chamber 12 is a hydraulic equalization chamber. The second chamber 14 is a chemical meting chamber and holds an initial volume of cleaning or treating fluid. References herein to a cleaning or treating or treatment fluid or solution or the like include any substance that provides a cleaning, treating, disinfecting, or air freshening effect at a desired dispensing location and may include chemicals and/or biological (such as bacterial) components. First chamber 12 preferably comprises a first valve 16 and second valve 18. Tubing 20 is connected to second valve 18. Tubing 22 is connected to second chamber 14 by outlet port 34, with its other end being directed to a desired location for dispensing an amount of cleaning or treating fluid from second chamber 14.

First chamber 12 and second chamber 14 are preferably cylindrical, but other shapes and varying sizes may be used. Any materials may be used for chambers 12 and 14, but they should be suitable for contact with the liquid (and gas) in the fluid tank in which apparatus 10 will be used. Additionally, the material for chamber 14 should be suitable for the contact with the cleaning or treating fluid it will hold. An opening 26 is disposed at the lower end of chamber 12 to allow fluid communication between the liquid in the tank, reservoir, or other fluid system in which apparatus 10 is to be located and the interior of chamber 12. Opening 26 may be the entire lower end of chamber 12 or it may be a smaller opening in or near a bottom surface of chamber 12. Valves 16 and 18 are disposed on an upper end 30 of chamber 12, with upper end 30 otherwise being sealed. Valves 16 and 18 are one-way valves. Valve 16 is a check valve that permits gas (usually air) from the tank (not depicted) in which apparatus 10 is used to enter chamber 12. Valve 18 permits gas from chamber 12 to enter chamber 14, but prevents backflow of cleaning or treating fluid from chamber 14 into chamber 12 (which is open to the liquid in the tank). Valve 18 is connected to tubing 20 to permit fluid communication of gas from the first chamber 12 to the second chamber 14. Tubing 20 is most preferably made from rigid tubing material, but other materials may be used. Chamber 14 preferably comprises inlet port 32 to connect to tubing 20 and outlet port 34 to connect to tubing 22. Either or both of ports 32 and 34 may be separate parts or may be unitarily molded with chamber 14. Outlet port 34 also connects to tubing 36 that extends to the lower end of chamber 14 so that substantially all of the cleaning or treating fluid may be dispensed over the course of repeated dispensing cycles.

Chamber 14 may also have a removable closure 24 to allow chamber 14 to be opened and periodically re-filled with cleaning or treating fluid. Closure 24 may have other shapes and may form part of a larger removable lid on chamber 14. When a larger lid is used, one or both of ports 32 and 34 may be disposed on the lid or unitarily molded as part of the lid. Various configurations for closure 24 (or the alternative lid), such as twist-off, compression, pop top, heat sealed or sonic welded, may be used. Alternatively, apparatus 10 may be packaged and sold with chamber 14 pre-filled with cleaning or treating fluid and designed so that the entire apparatus 10 is disposed of and replaced with a new apparatus 10 when the volume of fluid in chamber 14 is depleted. Alternatively, chamber 14 may be separately packaged and sold as a pre-filled product that is disposed of when the fluid in chamber 14 is depleted at the end of treatment cycle and replaced with a new chamber 14, with chamber 12 and/or tubing 20 or 22 remaining in the fluid tank for reuse over a number of treatment cycles. Those of ordinary skill in the art will understand the various removable closures that may be added to chamber 14 and/or ports 32 and 34 to seal its contents for shipping and sale until it is time to use apparatus 10, as well as quick connect fittings that may aid in connecting chamber 14 to the rest of apparatus 10 if chamber 14 is disposed of at the end of a treatment cycle and replaced with another pre-filled chamber to start a new treatment cycle.

In use, apparatus 10 is preferably placed in a tank (not shown) containing a variable volume of liquid and gas (air), such as a toilet tank. During normal use or operations, the tank varies between a substantially pre-set high level and low level of liquid. Opening 26 in chamber 12 should be located in the tank so that it is below the high liquid level in the tank, so that when the tank is at a high level state, liquid from the tank partially fills chamber 12 through opening 26. However, chamber 12 should be located such that the lower end of valve 18 (disposed inside chamber 12) is not submerged when the tank is at the high level state. Similarly, the upper end of valve 16 should be located above the high liquid level in the tank. In the preferred configuration depicted in FIGS. 1-2, if the lower end of valve 18 is above the high liquid level then the upper end of valve 16 is also above the high liquid level. Most preferably chamber 12 is located so that opening 26 is located between the high and low liquid levels in the tank. Either or both of chambers 12 or 14 may be pre-marked with a desired location for the where the high liquid level should contact apparatus 10 to make installation of apparatus 10 easier.

When properly located in the fluid tank, chamber 12 is partially filled with liquid from the tank when in the high level state (such as when the toilet is not being flushed). When the liquid level in the tank drops (such as when the toilet is flushed), the liquid level in chamber 12 also drops and the pressure change causes the space inside chamber 12 between the liquid line and the upper end 30 to fill with gas (usually air) from the tank through valve 16. It is possible that the liquid level in the tank relative to opening 26 would drop low enough that gas may also enter chamber 12 through opening 26. That does not interfere with operation of apparatus 10. When the liquid in the tank rises again, the liquid level in chamber 12 also rises and the pressure causes gas to exit chamber 12 through valve 18, tubing 20, and to enter chamber 14. The air entering chamber 14 displaces the cleaning or treating fluid in chamber 14, causing it to be dispensed through tubing 36, outlet port 34, and tubing 22 to a desired location. When used as a cleaning solution in a toilet tank, tubing 22 preferably dispenses cleaning fluid from chamber 14 directly into the toilet bowl, such as through the refill or overflow tube, rather than into the toilet tank. When used as a treating solution for a septic tank, tubing 22 may dispense the treatment fluid from chamber 14 to a location near the tank flapper so the treatment is flushed from the toilet to the septic tank.

When the pressure equalizes and the liquid in the tank has returned to (or near) the high level state, no further gas is pushed from chamber 12 to chamber 14 and the dispensing of cleaning or treating fluid stops until the next cycle of volume change in the fluid tank. With minor variations, the same amount of cleaning or treating fluid is dispensed from chamber 14 during each cycle. Those of ordinary skill in the art will understand how the size of the apparatus, the concentration of cleaning or treating fluid in chamber 14, and/or the operating conditions (such as the variance between the tank's high and low fluid levels) may be modified to alter the amount/volume of cleaning or treating solution dispensed from chamber 14 during each cycle or to alter the concentration of cleaning or treating fluid finally obtained when the dispensed amount is mixed with other liquid receiving the treatment (such as the water in a toilet bowl).

Most preferably, tubing 22 delivers the treatment or cleaning fluid to a location for treatment or cleaning outside of the tank in which apparatus 10 is being used. For example, when used in a toilet tank, tubing 22 preferably delivers the treatment or cleaning fluid directly into the refill or overflow tube so that it is discharged into the toilet bowl at the end of a flush (after the tank is emptied or substantially emptied and the bowl is filling), rather than discharging it inside the toilet tank. This provides several benefits for the system in which apparatus 10 is being used. Two of these benefits are longer residence time for the treatment or cleaning fluid within the discharge area that requires treatment (such as the toilet bowl) and reduced product load necessary to achieve the same functional effect (such as cleaning, treating, disinfecting, and/or air freshening), because the treatment or cleaning fluid is not being flushed out of the system as it would if it were discharged into the tank. This allows for more efficient usage of the cleaning or treating fluids, allowing smaller quantities and/or concentrations of active ingredients to be used and providing a cost savings over prior art systems that put the cleaning or treating fluid into the tank. Another benefit is that it eliminates the contact between the chemicals, biologicals, disinfectants or other cleaners that may be part of the treatment or cleaning fluid and the internal components of the tank in which apparatus 10 is used, as the treatment or cleaning fluid may be corrosive or otherwise damaging to the internal components of the system in which apparatus 10 is used. Although there is brief contact with the interior of the refill or overflow tube, the prolonged contact with the other internal components of the tank that occurs with prior art systems that dispense the cleaner or treatment into the tank is avoided.

It is preferred that chambers 12 and 14 be located in close proximity to each other, but that is not necessary provided the tubing 20 is of sufficient length to connect the two chambers. Additionally, the feed source for supplying fluid to refill the tank in which chamber 12 is disposed may be located remotely from the tank and apparatus 10. The refill fluid may be supplied to the tank by from another tank, pond, lake, municipal water supply or other fluid source by gravity, pump, or other pressurized device. For example, a toilet is typically connected to a pressurized water supply line from a municipal water source. Chambers 12 and 14 may be separate parts or they may be unitarily molded as a single unit. If separate parts, they are preferably supported by a single base or housing unit or are mechanically connected together, such as by strapping, to keep them in close proximity to each other. Apparatus 10 also preferably comprises one or more hanging brackets (no depicted) to allow apparatus 10 to be hung in the fluid tank at the desired level. If chambers 12 and 14 are unitarily molded, mechanically connected or supported by a single base or housing unit, then a single bracket may be used. If they are spaced apart from each other, two brackets may be used. The bracket(s) may have a hook to extend over and hang from the upper lip of the fluid tank, but other attachment or hanging methods may be used as such brackets are well known to those of ordinary skill in the art. As the mechanical parts of many toilet tanks are now standardized, the high water level is generally the same distance from the upper lip of the tank for most toilets, so a standard length hanging bracket may be used for most toilet tank installations. But the hanging bracket may be adjustable in length to accommodate use of apparatus 10 in other types of tanks or in non-standard toilet designs to allow proper placement of apparatus 10 relative to the high liquid level in the tank.

Apparatus 10 is particularly useful in toilet tanks and in facilities having multiple toilets, such as hotels, entertainment complexes, public restrooms, homes, and restaurants. Apparatus 10 may also be useful in numerous applications involving fluctuating hydraulic fluid systems other than the toilet tank applications described herein. For example, apparatus 10 may be used to mete: saline additive to a fish tank; additives onto bulk RTU tanks for cleaning machinery; cleaning solutions into mop buckets; fuel additives for fuel tanks of various types of machines, military tanks, airplanes, vehicles, motorcycles, boats, trains, mining equipment; chlorine/bromine additive or pH modifiers into swimming pools and spas; liquid foods sources for green houses; anti-freeze additive for automotive windshield washer reservoirs; CIP solutions for food processing/cooking tanks; food/medicinal additives to livestock watering troughs; insecticide solutions to inset control systems; flavor additives to beverage products; treatments for cooling towers; industrial/retail cleaning additives into water for bulk RTU products. References herein to the system in which apparatus 10 is used or located include those systems in which part of apparatus 10 is used or located, as chamber 12 may be located remotely from chamber 14 and references herein to a tank in which chamber 12 or any other part of system 10 are disposed include other structures, such as a reservoir, capable of holding a volume of liquid and include any type of system having a varying volume of liquid and gas. Those of ordinary skill in the art will also appreciate upon reading this specification and the description of preferred embodiments herein that modifications and alterations to the device may be made within the scope of the invention and it is intended that the scope of the invention disclosed herein be limited only by the broadest interpretation of the appended claims to which the inventors are legally entitled.

We claim:

1. A meting apparatus for use in a tank holding a variable volume of liquid and air, the meting apparatus comprising:
a first chamber configured to be in two way fluid communication with the fluid in the tank;
a second chamber holding an initial volume of a cleaning or treating solution, the second chamber in one-way fluid communication with the first chamber; and
a discharge tube in fluid communication with the solution in the second chamber.

2. The apparatus according to claim 1 wherein the first chamber comprises first and second one-way valves, the first valve permitting air from the tank to enter the first chamber and the second valve permitting air from the first chamber to enter the second chamber.

3. The apparatus of claim 2 wherein air entering the second chamber displaces a volume of solution from the second chamber through the discharge tube.

4. The apparatus of claim 2 wherein the air is exchanged between the tank and the first and second chambers in response to pressure changes due to variation in the volume of liquid in the tank.

5. The apparatus of claim 1 further comprising a marking indicating where the apparatus should be located within the tank relative to the high liquid level in the tank.

6. The apparatus of claim 1 wherein the discharge tube comprises two ends, a first end in fluid communication with the solution in the second chamber and a second end configured to discharge the solution to a desired location outside the tank.

7. The apparatus of claim 6 wherein the tank is a toilet tank and the second end is disposed within the refill or overflow tube inside the tank to discharge the solution into a toilet bowl.

8. A method of meting a liquid in a system comprising a tank having variable volumes of liquid and gas, a first chamber having a lower end in fluid communication with the liquid in the tank and an upper end in fluid communication with the gas in the tank, the volumes of liquid and gas in the first chamber varying as the volumes in the tank vary, and a second chamber having the liquid to be meted, the second chamber in fluid communication with the gas in the first chamber, the method comprising:
discharging at least a portion of the liquid from the tank to decrease the volume of liquid and increase the volume of gas in the first chamber;
supplying the tank with additional liquid to at least partially refill the tank and to create a change in pressure inside the first chamber;
displacing a volume of the liquid to be meted from the second chamber with a substantially equal volume of gas from the first chamber in response to the change of pressure in the first chamber;
dispensing the displaced volume of liquid through a discharge port in the second chamber.

9. The method of claim 8 wherein the liquid supplied to the tank is sufficient to refill the tank to substantially the same volume of liquid prior to the discharging step, to equalize the pressure in the first chamber and to stop dispensing the liquid.

10. The method of claim 8 wherein the liquid supplied to the tank is from a source remote to the tank and is supplied by gravity, pump, or other pressurized device.

11. The method of claim 8 wherein the displaced volume of liquid is dispensed to a treatment location disposed externally to the tank so that the liquid to be meted does not contact an interior of the tank.

12. The method of claim 8 wherein the discharging and supplying steps are periodically repeated until substantially all of the liquid in the second chamber has been dispensed.

13. The method of claim 12 further comprising the step of refilling the second chamber with the liquid to be meted once substantially all of the liquid in the second chamber has been dispensed.

14. The method of claim 12 further comprising delivering the dispensed liquid from the discharge port in the second chamber to a treatment area and contacting the delivered liquid with components in the treatment area.

15. The method of claim 14 wherein the treatment area is located externally to the tank, the tank is in fluid communication with the treatment area, and the dispensed liquid is not dispensed into the liquid in the tank prior to being dispensed to the treatment area.

16. The method of claim 15 wherein the liquid to be meted is a cleaning or treating solution and a residence time for contacting the cleaning or treating solution is increased by delivering the solution to an external treatment area.

17. A method of automatically dispensing a cleaning or treating solution in a toilet having a tank with a volume of gas and water that is variable when the toilet is flushed and a bowl configured to hold water between flushes, the method comprising:
placing a dispensing system within the tank, the dispensing system comprising a first chamber having a lower end in fluid communication with the water in the tank and an upper end in fluid communication with the gas in the tank, the volumes of water and gas in the first chamber varying as the volumes in the tank vary, and a second chamber having a volume of the cleaning or treating solution, the second chamber in fluid communication with the gas in the first chamber;
periodically flushing the toilet;
supplying the tank with additional water to at least partially refill the tank after each flush and to create a change in pressure inside the first chamber which forces a portion of the gas from the first chamber into the second chamber; and
dispensing to the bowl with each flush an amount of the cleaning or treating solution that is displaced by the portion of gas entering the second chamber.

18. The method of claim 17 further comprising refilling the second chamber with cleaning or treating solution after substantially all of the solution has been dispensed to the bowl

19. The method of claim 17 further comprising contacting the cleaning or treating solution with the bowl between flushes to provide a residence time for the solution to clean or treat the bowl and water in the bowl; and wherein the cleaning or treating solution is not dispensed into the water in the tank prior to being dispensed into the bowl to lengthen the residence time in the bowl between flushes.

20. The method of claim 19 wherein the dispensing step comprises delivering the amount of the cleaning or treating solution that is displaced to the refill or overflow tube within the tank so that it is dispensed into the bowl at the end of a flush and as the bowl is being refilled.

21. The method of claim 19 wherein the lengthened residence time permits use of solutions having lower concentrations of active ingredients than would be required to achieve substantially the same level of cleaning or treating if the solution were dispensed into the water in the tank prior to being dispensed into the bowl.
